(19) United States
(12) Patent Application Publication
(10) Pub. No.: US 2010/0122278 A1
(43) Pub. Date: May 13, 2010

(54) METHOD AND AN AUTOMATED DIRECTION FOLLOWING SYSTEM

(76) Inventor: Alfred Xueliang Xin, Cincinnati, OH (US)

Correspondence Address: Alfred Xueliang Xin, 6310 Copperleaf Lane, Cincinnati, OH, 45230, US

(21) Appl. No.: 12/270,018

(22) Filed: Nov. 13, 2008

(51) Int. Cl. H04H 60/33; G06K 9/00

(52) U.S. Cl. 725/12; 382/103

(57) ABSTRACT

A method and further an automated direction following system invented according to the said method are disclosed. The system comprising a position tracking system composed of a signal-sending device and a positioning detecting device receiving the signals, or a body tracking device; a micro-processor that is capable of processing signals prior described and generating commands for a multi-directional driving mechanism; A multi-directional driving mechanism that is capable receiving commands and of producing horizontal, or and vertical movements is configured with the said micro-processor and is designed to drive the functional object (TV set, computer, game or equipment monitors, equipment mounting units, convenient life unit or other forms of functional units) is either installed or integrated with the functional object and enables the functional object directly facing the signaling-sending unit, or follows the signaling-sending device, or the body tracking target within desired distance.

### BACKGROUND OF THE INVENTION

This invention relates to television, computer, game or equipment monitors and video system or other monitoring devices, and more particularly a system that is capable of enabling television, computer, game or equipment monitors and video system, or any monitoring devices to follow viewer or watcher with the best watching positions by turning screen or monitor directly facing the viewer or watcher when the viewer or watcher moves around with any angles within viewable areas where television, computer, game or equipment monitors, or video display terminal or other monitoring devices located, and still further the invented system may be used for other purposes, such as assisting people with physical impaired conditions for daily living.

Systems with such capabilities and functions are none-known in the prior art, a system needs to be invented to solve this problem. This invented system may also be utilized for handicapped people for convenient daily functions, or following them physically for easy reaching, and it may also be valuable implications on military, security monitoring, office and other environments for efficient and effective monitoring at any given positions within a range.

### SUMMARY OF THE INVENTION

In accordance with the present invention, an automated direction following system comprising a positioning detecting unit consists of a position tracking system, or a body tracking device; a controlling unit that processes signals from the signal receiving and processing device or the body tracking device; has a microprocessor that is capable of processing signals received and processed for locating positions of the sender and generating commands for multi-directional driving mechanism; A multi-directional driving mechanism that is capable receiving commands and of producing horizontal, or and vertical movements is configured with the controlling unit and is designed to drive the functional object (TV set, computer, game or equipment monitors, video monitoring device, equipment mounting units, convenient life unit or other forms of functional units) is either installed or integrated with the functional object and enables the functional object directed to the signaling-sending unit, or follows the signaling-sending device, or the body tracking target within desired distance.

These and other features, aspects and advantages of the present invention will become better understood with reference to the following drawings, descriptions and claims.

### BRIEF DESCRIPTION OF THE DRAWINGS

FIG. 1 is the illustrations of an embodiment of the automated direction following system with a position tracking system and also capable of positioning processing device as means of locating and positioning of the user.

FIG. 2 is the illustration of a different embodiment of the automated direction following system with body tracking device as means of locating and positioning of the user.

FIG. 3 is the illustrations of the controlling unit of the automated direction following system that receives positioning data and further processes the said data, and creates commands for a multi-directional driving mechanism.

FIG. 4 is the illustrations of another embodiment of the automated direction following system with a position tracking system and also capable of positioning processing device as means of locating and positioning of the user.

FIG. 5 is the illustration of still another different embodiment of the automated direction following system with body tracking device as means of locating and positioning of the user.

FIG. 6 is the illustrations of the controlling unit of the automated direction following system that receives positioning data and further processes the said data, and creates commands to drive a directional driving mechanism, and also keep a designed distance between the system and user.

### DETAILED DESCRIPTION OF THE INVENTION

The following detailed description is of the best currently contemplated modes of carrying out the present invention. The description is not to be taken in a limiting sense, but is made merely for the purpose of illustrating the general principles of the invention, since the scope of the invention is best defined by the appended claims.

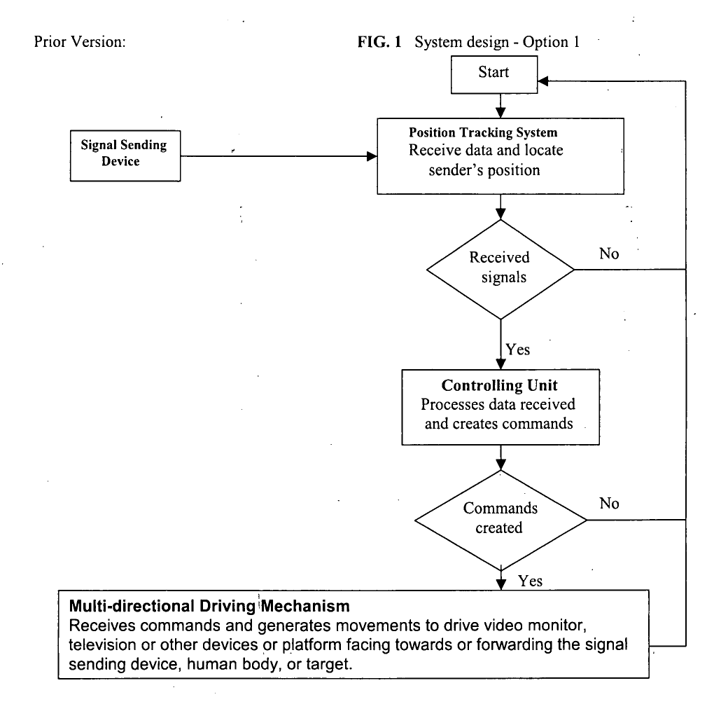

Referring now to the drawings in details, and particularly FIG. 1, a preferred embodiment of the automated direction following system is illustrated. The system comprising a position tracking system composed of a signal-sending device and a positioning detecting device receiving the signals. The signal-sending device sends out signals and the signal-receiving device receives the signals and is capable of positioning the signals received, data received from the said device are ready to be processed through a controlling unit configured with the said device.

A controlling unit that processes positioning data received from the signal tracking device has a microprocessor that is capable of processing signals received and generating commands for a multi-directional driving mechanism;

A multi-directional driving mechanism that is capable of receiving commands and of producing horizontal, or and vertical movements is configured with the controlling unit and is designed to drive the functional object (TV set, computer, or game monitor, equipment mounting units, convenient life unit or other forms of functional units) is either installed or integrated with the functional device or equipment and moves the functional object directed to the signaling-sending device.

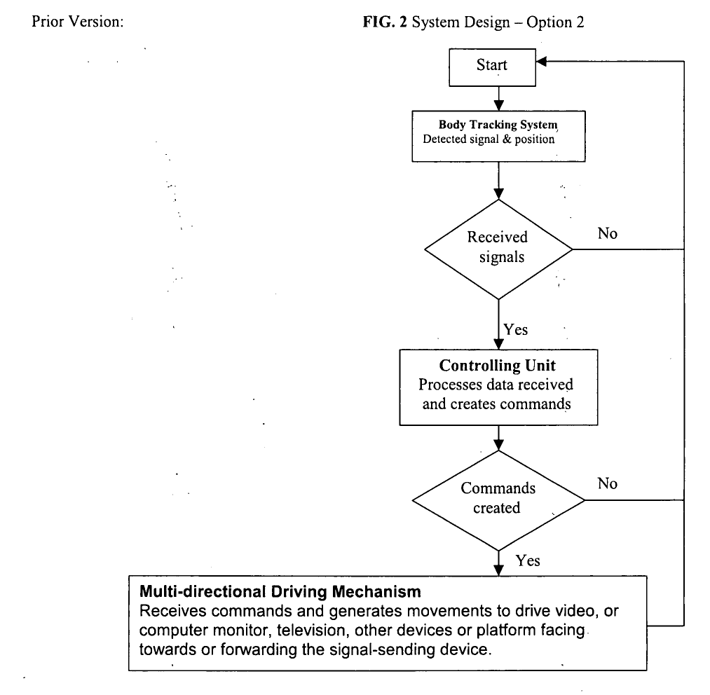

Referring now to the drawings particularly FIG. 2, a preferred embodiment of the automated direction following system is illustrated. A system consists of a body tracking device. The said device receives heat generated signals and is capable of positioning the signals received, data received from the said device are ready to be processed through a controlling unit configured with the said device.

A controlling unit that processes positioning data from the body tracking device has a microprocessor that is capable of processing signals received and generating commands for a multi-directional driving mechanism;

A multi-directional driving mechanism that is capable receiving commands and of producing horizontal, or and vertical movements is configured with the controlling unit and is designed to drive the functional object (TV set, computer or game monitor, equipment mounting units, convenient life unit or other forms of functional units) is either installed or integrated with the functional device or equipment and enables the functional object directed or faced to the body tracking target within designed the angle range.

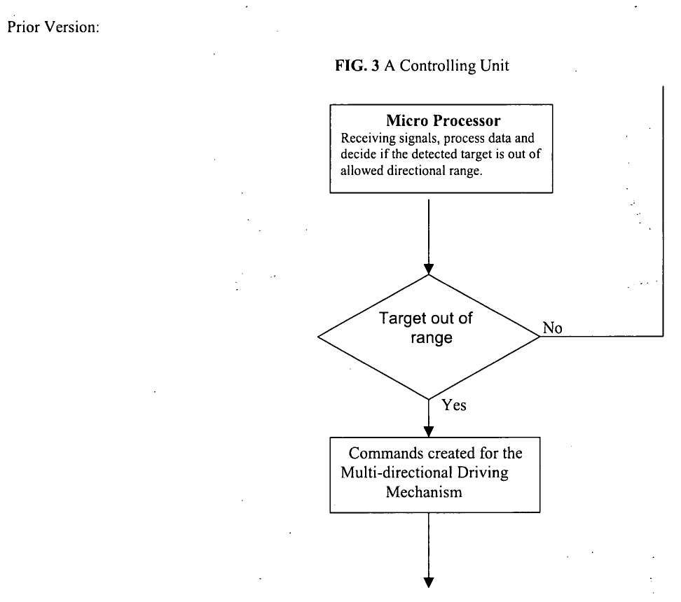

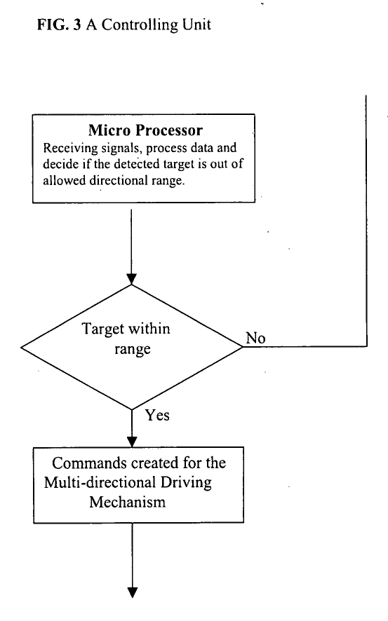

Referring now to the drawings particularly FIG. 3, the controlling unit that processes positioning data from the position tracking systems has a microprocessor that is capable of processing data received and generating commands for a multi-directional driving mechanism to move the system back or face to the user.

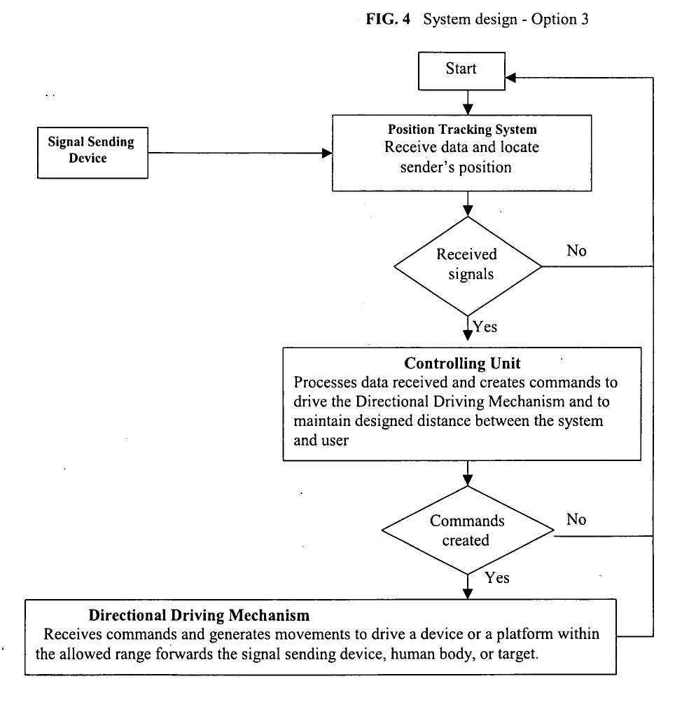

Referring now to the drawings in details, and particularly FIG. 4, a preferred embodiment of the automated direction following system is illustrated. A system comprising a position tracking system composed of a signal-sending device and a positioning detecting device receiving the signals. The signal-sending device sends out signals and the signal-receiving device receives the signals and is capable of positioning the signals received, data received from the said device are ready to be processed through a controlling unit configured with the said device.

A controlling unit that processes positioning data from the position tracking system has a microprocessor that is capable of processing signals received and generating commands for a directional driving mechanism;

A directional driving mechanism that is capable receiving commands and of producing movements in different directions is configured with the controlling unit and is designed to drive the functional object (equipment mounting units, convenient life unit or other forms of functional units) is either installed or integrated with the functional device or equipment and moves the functional object directed to the signaling-sending device, or followed the position tracking system or the body tracking target within desired distance.

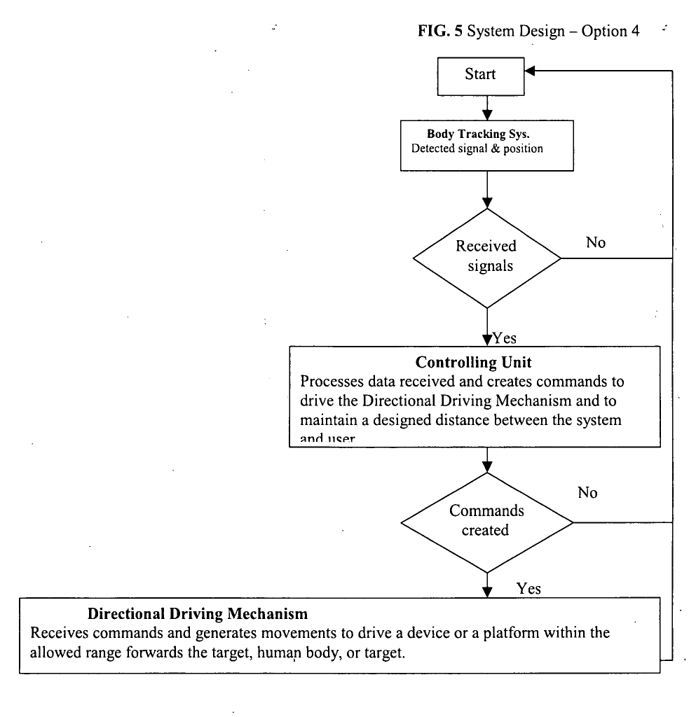

Referring now to the drawings particularly FIG. 5, a preferred embodiment of the automated direction following system is illustrated. A system consists of a body-tracking device. The said device receives heat generated signals and is capable of positioning the signals received, data received from the said device are ready to be processed through a controlling unit configured with the said device.

A controlling unit that processes positioning data from the body tracking device has a microprocessor that is capable of processing signals received from the said device and generating commands for a directional driving mechanism;

A directional driving mechanism that is capable receiving commands and of producing movements in different directions is configured with the controlling unit and is designed to drive the functional object (equipment mounting units, convenient life unit or other forms of functional units) is either installed or integrated with the functional device or equipment and enables the functional object directed to the target located by body tracking device, or follows the said target within desired distance.

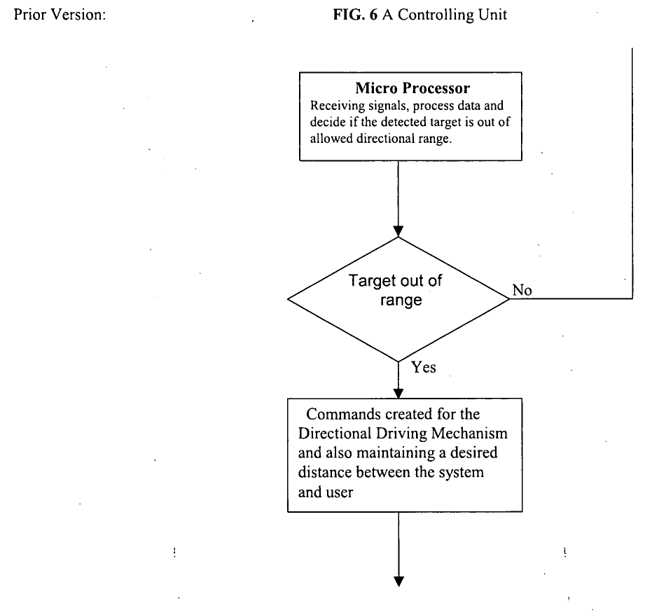

Referring now to the drawings particularly FIG. 6, the controlling unit that processes positioning data from the position tracking systems has a microprocessor that is capable of processing data received and generating commands for a directional driving mechanism based on the preset range allowance and preset correcting logics.

It claims:

1. An automated direction following system comprising:
A position tracking system consists of a signal-sending device, a signal-receiving device and signal positioning device, or;
A body tracking system that detects human body heat and is capable of following its physical positions, and sends data generated according to the target position.
A controlling unit has a microprocessor that is capable of processing data indicating positions and based on the said data generates commands for a multi-directional driving mechanism;
A multi-directional driving mechanism that is capable of receiving commands and of generating horizontal, or and vertical movements is configured with the controlling unit and is designed to drive the functional object.

2. The automated direction following system of claim 1 wherein a position tracking system comprising of a signal-sending device which may be carried by the user or positioned, and a signal-receiving device that is capable of receiving the signals sent by the signal-sending device, and is capable of generating data to indicate the positions, horizontal or and vertical, of the signal-sending device, or

3. The automated direction following system of claim 2 wherein as of an optional signal detecting method a body tracking device that detects human body heat and is capable of following its physical positions, and is capable of generating data to indicate the positions of the human body.

4. The automated direction following system of claim 1 wherein the controlling unit comprises a microprocessor that is capable of processing the data from the position tracking system or the body tracking system, and of deciding if the data is within or out of allowed range, and further generates commands for the multi-directional driving mechanism.

5. The automated direction following system of claim 1 wherein the multi-directional driving mechanism comprises two-way rotating electrical motors or and magnetic mechanism that creates multi-directional driving forces generated by electrical power or other forms of energies, or any other forms of directional moving mechanism, and commands processing unit that is capable of accepting commands from the controlling unit described in claim 1 and further in claim 4, and that generates multi-directional movements, horizontal or and vertical.

6. The automated direction following system of claim 1 whereof the system may be configured with devices such as television, computer, game, equipment or video monitor, any other equipments or platforms, or as independent working system and has configuration means ready to have the devices or equipments installed.
As the automated direction following system functions, screens of the said devices or equipments shall follow and directly face to the user or the watcher and maintain the best viewing or watching angle to the user or the watcher.

7. An automated direction following system comprising:
A position tracking system consists of a signal-sending device and a signal-receiving device and signal positioning device, or;
A body tracking system that detects human body heat and is capable of following its physical positions, and sends data generated according to the target position.
A controlling unit has a microprocessor that is capable of processing data indicating positions and based on the said data generates commands for directional driving mechanism, and is also capable of keeping the directional driving mechanism within or and at desired distance with the user;
A directional driving mechanism that is capable receiving commands and of generating driving movements in different directions is configured with the controlling unit and is designed to drive the functional equipment or object.

8. The automated direction following system of claim 7 wherein a signal-sending device and receiving system that comprising of a signal-sending device which may be carried by the user or positioned, and a signal-receiving device that is capable of receiving the signals sent by the signal-sending device, and is capable of generating data to indicate the positions of the signal-sending device, or

9. The automated direction following system of claim 8 wherein as of an optional signal detecting method a body tracking device that detects human body heat and is capable of following its physical positions, and is capable of generating data to indicate the positions of the human body.

10. The automated direction following system of claim 7 wherein the controlling unit comprises a microprocessor that is capable of processing the data from the position tracking system or the body tracking system, and of deciding if the data is within or out of allowed range, and further generates commands for the directional driving mechanism, and is also capable of keeping the directional driving mechanism within or and at desired distance from the user.

11. The automated direction following system of claim 7 wherein the directional driving mechanism comprises two-way rotating electrical motors or and magnetic mechanism that creates directional driving forces generated by electrical power or other forms of energy, or any other forms of directional moving mechanism, and commands processing unit that is capable of accepting commands from the controlling unit described in claim 7 and further in claim 10, and that generates movements in different directions.

12. The automated direction following system of claim 7 whereof the system may be configured with a device, an equipment or a platform, or as independent working system and has configuration means ready to have a device or an equipment installed.
